(19) United States
(12) Patent Application Publication
(10) Pub. No.: US 2013/0132052 A1
(43) Pub. Date: May 23, 2013

(54) SYSTEM AND METHOD FOR ASSESSING HETEROGENEITY OF A GEOLOGIC VOLUME OF INTEREST WITH PROCESS-BASED MODELS AND DYNAMIC HETEROGENEITY

(71) Applicants: Michael D. Hogg, Montgomery, TX (US); Michael James Pyrcz, Humble, TX (US); George Michael Shook, Houston, TX (US)

(72) Inventors: Michael D. Hogg, Montgomery, TX (US); Michael James Pyrcz, Humble, TX (US); George Michael Shook, Houston, TX (US)

(73) Assignee: Chevron U.S.A. Inc., San Ramon, CA (US)

(21) Appl. No.: 13/300,084

(22) Filed: Nov. 18, 2011

(51) Int. Cl. G06G 7/48

(52) U.S. Cl. 703/6

(57) ABSTRACT

Heterogeneity of a geological volume of interest is assessed. The heterogeneity of the geological volume of interest may refer to the quality of variation in rock properties within location in the geological volume of interest. An accurate and/or precise assessment of the heterogeneity of the geological volume of interest may enhance modeling, formation evaluation, and/or reservoir simulation of the geological volume of interest, which may in turn enhance production from the geological volume of interest. As described herein a stochastic, process-based modeling approach to modeling the geological volume of interest, along with a determination of dynamic heterogeneity may be leveraged to quantify the heterogeneity of the geological volume of interest.

### FIELD

The disclosure relates to assessing the heterogeneity of a geological volume of interest using stochastically generated process-based earth models and determinations of dynamic heterogeneity made from the earth models.

### BACKGROUND

Historically, reservoir systems have been characterized with deterministic and stochastic methods. The models consist of single cases or multiple realizations combining geological data, engineering data, and human expertise into a single model or multiple models believed to be the best subsurface representation of the reservoir and associated uncertainty with available data. In exploration and appraisal settings, however, well control is sparse and subsurface imaging of architecture with seismic data is frequently problematic. Consequently model inaccuracies are manifold including those of interpreters and modelers owing to information gaps and lack of experience. Consequences of anchoring on a given scenario include wide divergence between model-based predictions and observed reservoir performance.

Often geologic models are constructed with insufficient linkage to flow performance. This is due to inability of the geologic models to capture the necessary geologic complexity, complexity of flow response and inability to summarize flow behavior in a concise, understandable, yet generally applicable manner.

### SUMMARY

One aspect of the disclosure relates to a method of generating a geostatistical model of a geological volume of interest. In some embodiments, the method comprises stochastically generating a set of process-based models of the geological volume of interest, including a first model and a second model, wherein generating the first model includes separately stochastically generating a plurality of successive geological process events to form the first model of the geological volume of interest, and wherein generating the second model includes separately stochastically generating a plurality of successive geological process events to form the second model of the geological volume of interest; calculating dynamic heterogeneities for the individual models in the set of process-based models of the geological volume of interest such that a dynamic heterogeneity for the first model is determined and a dynamic heterogeneity for the second model is determined; and analyzing the dynamic heterogeneities determined for the individual models in the set of process-based models to obtain a quantification of likely heterogeneity of at least a portion of the geological volume of interest.

Another aspect of the disclosure relates to a system configured to generate a geostatistical model of a geological volume of interest. In some embodiments, the system comprises one or more processors configured to execute computer program modules. The computer program modules comprises a model module, a model heterogeneity module, and a volume module. The model module is configured to stochastically generate a set of process-based models of the geological volume of interest, including a first model and a second model. Generation of the first model includes separately stochastically generating a plurality of successive geological process events to form the first model of the geological volume of interest. Generation of the second model includes separately stochastically generating a plurality of successive geological process events to form the second model of the geological volume of interest. The model heterogeneity module is configured to calculate dynamic heterogeneities for the individual models in the set of process-based models of the geological volume of interest such that a dynamic heterogeneity for the first model is determined and a dynamic heterogeneity for the second model is determined. The volume heterogeneity module is configured to analyze the dynamic heterogeneities determined for the individual models in the set of process-based models to obtain a quantification of likely heterogeneity of at least a portion of the geological volume of interest.

Yet another aspect of the disclosure relates to a non-transitory, electronic storage medium having stored thereon processor readable instructions, wherein the instructions are configured to cause one or more processors to perform a method of generating a geostatistical model of a geological volume of interest. In some embodiments, the method comprises stochastically generating a set of process-based models of the geological volume of interest, including a first model and a second model, wherein generating the first model includes separately stochastically generating a plurality of successive geological process events to form the first model of the geological volume of interest, and wherein generating the second model includes separately stochastically generating a plurality of successive geological process events to form the second model of the geological volume of interest; calculating dynamic heterogeneities for the individual models in the set of process-based models of the geological volume of interest such that a dynamic heterogeneity for the first model is determined and a dynamic heterogeneity for the second model is determined; and analyzing the dynamic heterogeneities determined for the individual models in the set of process-based models to obtain a quantification of likely heterogeneity of at least a portion of the geological volume of interest.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is a method of assessing heterogeneity for a geological volume of interest.

FIG. 2 is a method of generating a stochastic process-based model of a geological volume of interest.

FIG. 3 is a method of determining dynamic heterogeneity of a earth model of a geological volume of interest.

FIG. 4 is a graph comparing a flow capacity-storage capacity curve calculated from streamline analysis to a flow capacity-storage capacity curve calculated analytically from static data.

FIG. 5 is a graph showing how the Flow Heterogeneity Index, which is an example of a Dynamic Heterogeneity Index, can be calculated from flow capacity-storage capacity curves.

FIG. 6 is a graph of a sweep efficiency curve.

FIG. 7 is a method of determining likeliness of an earth model.

FIG. 8 illustrates a response surface quantifying the interaction between various parameters of a geologic volume of interest.

FIG. 9 illustrates a look-up table quantifying the interaction between various parameters of a geologic volume of interest.

FIG. 10 illustrates a system configured to assess heterogeneity of a geological volume of interest.

### DETAILED DESCRIPTION

The present technology may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present technology may be coded in different languages for application in a variety of computing platforms and environments. It will be appreciated that the scope and underlying principles of the present technology are not limited to any particular computer software technology.

Moreover, those skilled in the art will appreciate that the present technology may be practiced using any one or combination of hardware and software configurations, including but not limited to a system having single and/or multi-processor computer processors system, hand-held devices, programmable consumer electronics, mini-computers, mainframe computers, and the like. The technology may also be practiced in distributed computing environments where tasks are performed by servers or other processing devices that are linked through one or more data communications networks. In a distributed computing environment, program modules may be located in both local and remote computer storage media including memory storage devices.

Also, an article of manufacture for use with a computer processor, such as a CD, pre-recorded disk or other equivalent devices, may include a computer program storage medium and program means recorded thereon for directing the computer processor to facilitate the implementation and practice of the present technology. Such devices and articles of manufacture also fall within the spirit and scope of the present technology.

Referring now to the drawings, embodiments of the present technology will be described. The technology can be implemented in numerous ways, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the present technology are discussed below. The appended drawings illustrate only typical embodiments of the present technology and therefore are not to be considered limiting of its scope and breadth.

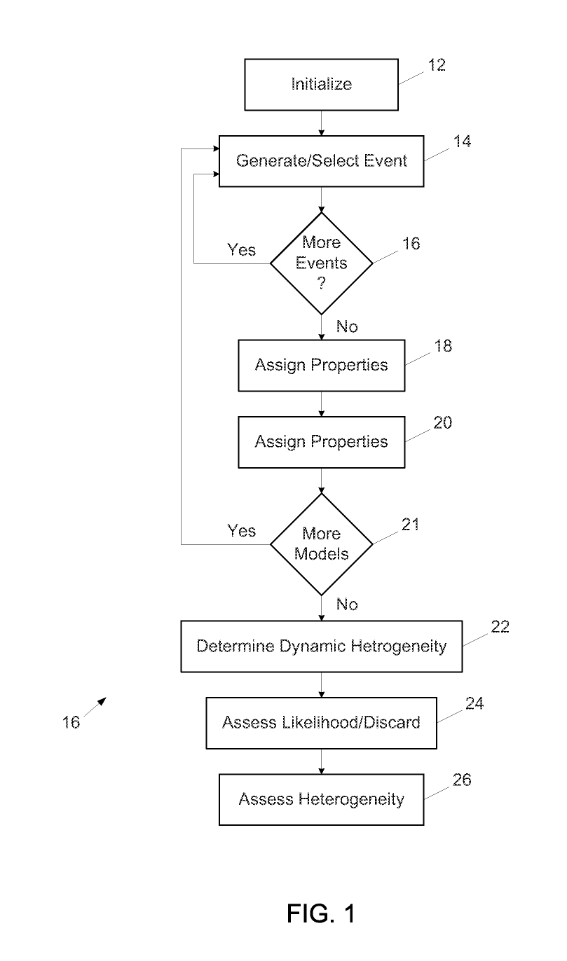

FIG. 1 illustrates a method 10 of assessing the heterogeneity of a geological volume of interest. The heterogeneity of the geological volume of interest may refer to the quality of variation in rock properties within location in the geological volume of interest. An accurate and/or precise assessment of the heterogeneity of the geological volume of interest may enhance modeling, formation evaluation, and/or reservoir simulation of the geological volume of interest, which may in turn enhance production from the geological volume of interest. Method 10 may leverage a stochastic, process-based modeling approach to modeling the geological volume of interest, along with a determination of dynamic heterogeneity to obtain an uncertainty space for the heterogeneity of the geological volume of interest. The technique for stochastic, process based modeling may be the same as or similar to the technique described in U.S. patent application Ser. No. 12/140,901, filed Jun. 17, 2008. The technique for determining dynamic heterogeneity of a geological volume of interest may be the same as or similar to the technique described in Ser. No. 12/637,898, filed Dec. 15, 2009. Both of the above-referenced applications are hereby incorporated by reference in their entirety into the present application.

At an operation 12, the generation of a model of the geologic volume of interest is initialized. This may include obtaining initialization information related to the geologic volume of interest. Obtaining the information may include determining the information, generating the information, accessing the information from storage, receiving the information (e.g., over a network, through user interface, etc.), and/or obtaining the information in other ways. By way of non-limiting example, the initialization information may include initialization parameters such as parameters related to the reservoir type and scale of the geologic volume of interest (e.g., deepwater slope valley complex set, deepwater weakly confined channels, fluvial meander channel belt, fluvial braided channel complex, and/or other types), parameters related to the size and/or shape of the geologic volume of interest, parameters related to the geo-location of the geologic volume of interest, and/or other parameters. Initializing the generation of the model of the geologic volume of interest may include providing a baseline architecture upon which the model will be built. Initializing the model generation may include obtaining conditioning information associated with the geological volume of interest. Conditioning information includes direct measurements taken at or near the geological volume of interest. The conditioning information may include, for example, one or more of well log data, well cores, seismic data, trends inferred from local data and/or expert knowledge, geologic process and analogs, and/or other information. Initializing the model generation may include obtaining environmental information related to formation of the geological volume of interest. This information may describe and/or quantify environmental conditions present in geological time while the geological volume of interest was being formed. Such information may include, for example, sea level information, climate and temperature information, tectonic forces, sediment supply and/or other information.

At an operation 14, a first process event to be added to the model of the geological volume of interest is determined. This determination includes stochastically generating a plurality of potential process events for the first process event, and then selecting one of the potential process events as the first process. The selection of the first process event from the plurality of potential process events may be stochastic. The first process event is then added to the model of the geological volume of interest (e.g., on top of the baseline architecture).

At an operation 16, a determination is made as to whether additional process events should be added to the model of the geological volume of interest. To add additional process events to the model, method 10 returns to operation 14 and another process event is added to the model. Responsive to there being no further process events to be added to the model, method 10 proceeds to an operation 18.

At operation 18, the model architecture generated at operations 12, 14, and 16 is populated with sand and hierarchical trend properties. It will be appreciated that the description of operation 18 being performed subsequent to generation of all of the process events is not intended to be limiting. In some embodiments, the process events may be populated with these properties individually after being generated and/or selected. These properties related to various states at the time of deposition, such as energy, flow velocity, depth of water etc. and geometric descriptions such as near the base or margin of a channel or near the location of channel avulsion and various derived sediment properties from these states and input constraints such as lithology, grain size etc. These properties are derived through a combination of empirical relations and local and analog-based observations of the influence of state and geometric properties on sediment properties and heterogeneity. For example, in a simple case, observed deepwater channels have a predictable lithology transitions and reservoir properties from axis to margin and base to top of the channel cross sectional geometry. These are imposed utilizing local geometric coordinates within the channel geometry. In a more complicated example, initial distribution of grain size is placed along a channel as a function of local energy and flow capacity models.

At an operation 20, the model architecture generated at operations 12, 14, and 16 is populated with permeability, porosity, and saturations based on the properties. From the reservoir properties modeling in operation 18 calibrated with local and analog information and empirical relationships reservoir properties such as porosity, permeability and saturations are derived for all locations within the reservoir.

At an operation 21, a determination may be made as to whether one or more additional models of the geological volume of interest should be generated. Responsive to a determination that further models should be generated, method 10 may return to operation 14 to generate another model of the geological volume of interest. Responsive to a determination that not further models should be generated, method 10 may proceed to an operation 22.

At an operation 22, dynamic heterogeneity of the individual models of the geological volume of interest is determined. The dynamic heterogeneity for a given model is quantified by determining one or more heterogeneity metrics along flow paths through the given model. The flow paths are determined to reflect likely paths for fluid through the given model, rather than volumes having pre-specified geometric properties (e.g., separate layers through the model). As is discussed herein, the flow paths may be determined by an analysis of the given model that identifies paths through the given model. Such analysis may include, for example, a streamline analysis of the given model. The one or more heterogeneity metrics may include one or more of a Lorenz Coefficient, a Koval Factor, Flow Heterogeneity Index and/or other metrics indicating heterogeneity. The determination of the one or more heterogeneity metrics may include one or both of local and/or global determinations. A local determination of a heterogeneity metric may indicate values for the heterogeneity metric as a function of position within the given model.

At an operation 24, an assessment of likelihood that the individual models accurately reflect the geology of the geological volume of interest is made. This assessment may include, without limitation, a determination of probabilities for the individual models, and/or other indications of likelihood. The assessment may be made based on compliance to conditioning information, interdependencies between two or more parameters of the geological volume of interest, and/or based on other determinations or information. The assessment of likelihood may be based on a comparison of flow responses of the individual models with observed production data, with higher levels of correlation corresponding to relatively higher likeliness of accuracy.

At operation 24, some of the earth models may be selected for further processing, and/or some of the earth models may be rejected for further processing. This selection/rejection is made based on the probabilities of correspondence determined for the earth models at operation 24. In some embodiments, operation 24 selects a predetermined number of the earth models that have the highest probabilities of correspondence. The predetermined number may be configurable (e.g., via a user interface) by one or more users. In some embodiments, operation 24 selects the predetermined number of numerical analogs for further processing stochastically, using the probabilities of correspondence to weight the stochastic selection. In some embodiments, operation 24 compares the probabilities of correspondence with a predetermined threshold and selects the numerical analogs having probabilities of correspondence greater than the predetermine threshold for further processing. The predetermine threshold may be configurable (e.g., via a user interface) by one or more users.

It will be appreciated that the illustration of operation 24 as transpiring after the determination of dynamic heterogeneity at operation 22 is not intended to be limiting. In some embodiments, likelihood may be assessed prior to a determination of dynamic heterogeneity. Of course, in such embodiments, dynamic heterogeneity may not serve as one of the parameters used to assess likelihood (e.g., based on interdependency with one or more other parameters). Further, in some embodiments, method 10 may loop back to operation 14 subsequent to operation 24 to generate additional models implementing information discovered about the geological volume of interest through method 10 up to operation 24.

At operation 26, a likely heterogeneity of at least a portion of the geological volume of interest is determined from the models of geological volume of interest generated by the iterative execution of operations 12, 14, 16, 18, 20, 21, 22, and 24. The determination of likely heterogeneity may be made from the dynamic heterogeneities of the models. This determination may include a global determination and/or a local determination of likely heterogeneity. Likely heterogeneity may be expressed as an individual value (e.g., an aggregate of the models), as a range of potential heterogeneities, as a standard deviation, as local transition and variation in heterogeneities, and/or through other metrics, values or ranges. The determination of likely heterogeneity from the dynamic heterogeneities for the individual models may weight the individual dynamic heterogeneities. This weighting may be performed, for example, based on model likelihood (e.g., as discussed herein with respect to 24).

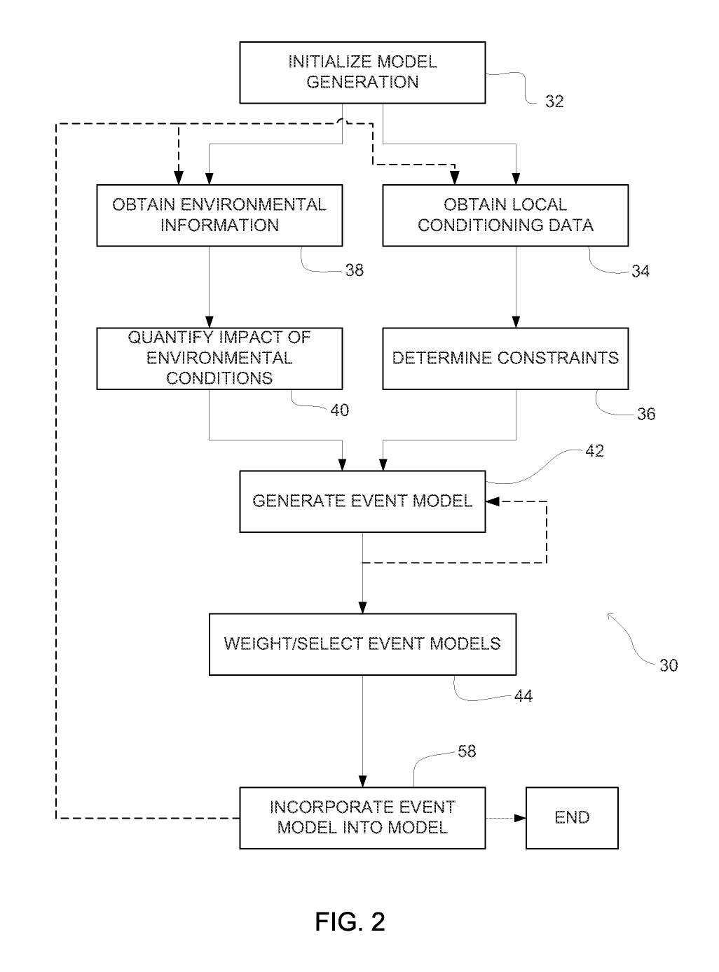

FIG. 2 illustrates a method 30 of stochastically generating a model of a geological volume of interest. In some embodiments, method 30 can be implemented in one or more of operations 12, 14, and/or 16 of method 10 (shown in FIG. 1 and described herein). However, it will be understood that this is not intended to be limiting, and that method 30 may be implemented in a variety of contexts.

At an operation 32, the generation of the model of the geologic volume of interest is initialized. This may include some or all of the features and/or functions described above with respect to operation 12 of method 10 (shown in FIG. 1).

At an operation 34, local conditioning data related to a first event within the geologic volume of interest is obtained. This may include obtaining local condition data for the first event from the global conditioning information for the geological volume of interest obtained previously at operation 32. Operation 34 may include interpreting local conditioning data to assign the likelihood of specific architectures that may honor this data. In some embodiments, operation 34 includes assigning specific architectures likelihoods corresponding to local conditioning data, and converting this into a probability of this data being honored by the resulting architecture model.

At an operation 36, constraints on the distribution of the one or more geologic parameters represented by the model of the geologic volume of interest within an event model of the first event are determined. The constraints are determined based on the local conditioning data related to the first event obtained at operation 34. A given constraint may directly constrain a geologic parameter, or may constrain a trend in a geologic parameter. For example, the distribution of event thickness in wells may constrain the thickness distribution of events, the frequency of amalgamated stacking or underfilled fill features in wells may constrain the frequency of events to exhibit organized stacking patterns, the frequency of isolated or overfilled events in wells may constrain the frequency of disorganized patterns or avulsion, the presence of bathymetry/topographic controls may constrain the source, orientations, geometries, and/or morphologies of events, and/or other geologic parameters may be constrained. The constraints are based on the local conditioning data, and are determined to facilitate conformance of the model to the local conditioning data.

The constraints for the first event may be determined based on the topologic and/or geologic features of the model of the geologic volume of interest subsequent to the first event (or based on the baseline architecture), local conditioning data corresponding to the first event and/or adjacent events, wells with no channel sand present may prevent, avulse or repulse subsequent events from crossing the well trajectory, a channel intercept of a specific thickness may constrain the actual thickness of the subsequent channel or force regression or progradation of the associated architectures, amalgamated stacking or underfilled channel fill of channels in the wells may constrain the subsequent events to exhibit organized stacking patterns, abandoned channel fills may constrain the location of channel avulsions and meander loop cutoffs, overbank facies may constrain the proximity of subsequent channels, seismic indicators may be coded as erodability constraints to limit the placement of events and/or other information may be implemented as constraints. By way of non-limiting example, the constraints determined at operation 36 may constrain one or more of the erodibility, event geometry, gradient, and/or other parameters or trends in parameters.

One or more of the constraints determined operation 36 may be, at least in part, a function of position within the geologic volume of interest. For example, a constraint may limit or constrain the determination of geologic parameters locally around a well-bore from which local conditioning data has been acquired. Such a constraint may have a hard boundary, or the impact of the constraint may fall off gradually as distance from the well-bore (or other constraint epicenter or source) increases. These “soft” boundaries may enhance the realism of the model in conforming to local conditioning data, in some instances.

At an operation 38, information related to environmental conditions that impacted the geological volume of interest at the time of formation of the first event is obtained. This may include accessing the appropriate information from the set of information obtained for the geological volume of interest generally at operation 32. Such information may include one or more of sea level, one or more tectonic conditions, one or more climate conditions (e.g., humidity, precipitation, temperature, wind conditions, dew point, etc.), a distribution of sediment types, discharge (e.g., the volume and/or composition of geologic materials and water entering the geologic volume of interest), and/or other environmental conditions.

At an operation 40, the impact of the information related to environmental conditions obtained at operation 38 on the geologic architecture of the geologic volume of interest during formation of the first event is determined. The quantification of this impact enables the model of the geologic volume of interest generated by method 30 to reflect the environmental conditions present as the geologic volume of interest was formed.

At operation 40, the impact of the environmental conditions present at the point in geologic time corresponding to the first event on the geologic parameters of the first event are determined. This quantification may include the determination of one or more constraints on the geologic parameters of the first event, one or more constraints on trends in the geologic parameters of the given event, and/or one or more variables that impacts the distribution of the one or more geologic parameters within the first event. For example, for the first event, operation 40 may determine one or more constraints on an architectural element size (e.g., a channel size), fractional fill, equilibrium profile, channel spectrum and/or sinuosity, channel fill trends, erodability, aggradation rate, and/or other constraints that impact the distribution of geologic parameters within the given event. By way of non-limiting example, in some embodiments, quantification of the impact of the information related to environmental conditions at operation 40 is performed in the manner described in above referenced U.S. patent application Ser. No. 12/140,901.

At an operation 42, an event model for the first event is stochastically generated. To generate the model of the first event within the geologic volume of interest, operation 42 stochastically determines a distribution of geologic parameters as a function of position within the geologic volume of interest that corresponds to an event flow from proximal to distal. The generation of the event model dynamically self-positions the event flow, and is governed by rules related to energy, inertia, and gradient. As such, the generation of the event model of the first event is based on topologic and/or geologic parameters of the model of the geologic volume of interest at the point in geologic time that corresponds to the first event. This means that the topologic and/or geologic parameters of previously modeled flow events (occurring previously in geologic time) impact the event model of the first event. In generating the stochastic distributions of the geologic parameters within the geologic volume of interest for the first event, operation 42 implements the quantification of the impact of environmental conditions on the first event determined at operation 40, and conforms to the constraints determined for the first event at operation 36.

Method 30 then loops back to operation 42 to stochastically generate a plurality of event models for the first event. In some embodiments, the loop may be performed to result in the generation of a predetermined number of event models for the first event. The predetermined number may be based on user input and may be updated by the performance of the events with respect to conditioning data match. Once the loop back over operation 42 is complete for the first event, method 30 proceeds to an operation 44.

At operation 44, a selection from among a plurality of event models determined for first event is made so that the selected event can be incorporated into the model of the geologic volume of interest. In some embodiments, to select from among the plurality of event models, operation 56 individually weights the event models based on the likelihood of the distributions of the one or more parameters within the event models corresponding to the actual distributions of the one or more parameters within the geologic volume of interest. The weights are determined based on the conformance of the individual event models to the local conditioning data.

Once the event models have been weighted, one of the event models is stochastically selected. While this selection is stochastic, it is also weighted by the individual weights. Thus, an event model with relatively bad conformance to the local conditioning data may be selected, but this selection would be relatively less likely due to the relatively low weight that would likely be assigned to this event model. In some embodiments, some of the generated event models may be discarded from the selection process based on bad conformance with the local conditioning data. In some embodiments, operation 44 considers constraints related to subsequent events beyond the current event. This may enhance the ability of method 30 to avoid becoming trapped in a subsequent event configuration that cannot honor conditioning data. In some embodiments, operation 44 may regressively reject previous events and allow method 30 to improve global conditioning.

At an operation 46, the event model selected at operation 44 is incorporated into the model of the geologic volume of interest. Incorporation of the model of the geologic volume of interest includes adjusting the one or more geologic parameters to conform more closely with the local conditioning data. Incorporation of the model of the geologic volume of interest may include adjusting the one or more geologic parameters (and/or the properties or distributions thereof) to ensure that the incorporation of additional event models into the model of the geologic volume of interest does not degrade conformance of the selected event model and the local conditioning data.

Method 30 then loops back over operations 34, 36, 38, 340, 42, 44, and/or 46 to generate event models for subsequent events within the geologic volume of interest (e.g., a second event , a third event, etc.) until the model of the geologic volume of interest is complete. Once the model of the geologic volume of interest is complete, method 30 is ended.

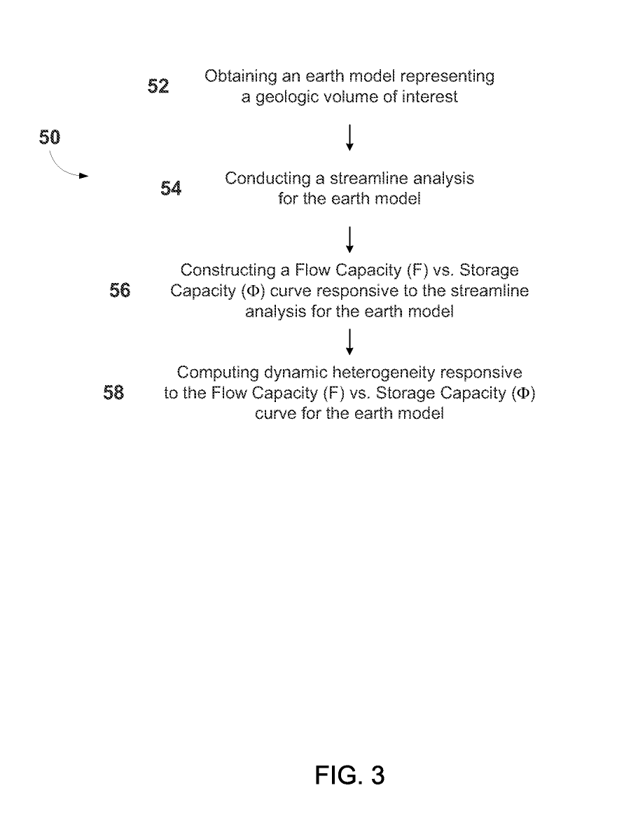

FIG. 3 illustrates method 50 of quantifying dynamic heterogeneity of an earth model. In some embodiments, method 50 is implemented for individual ones of a set of earth models at operation 22 of method 10 (shown in FIG. 1). It will be appreciated that this is not intended to be limiting, as method 50 may be implemented in a variety of contexts in accordance with the principles described herein. In particular, steps are employed to rank earth models based on a measure of dynamic heterogeneity.

An earth model representing a geological volume of interest is obtained at an operation 52 of method 50. Streamline analysis for the earth model is conducted at an operation 54. Flow Capacity (F) vs. Storage Capacity (Φ) curves are constructed for the earth model at an operation 56. The Flow Capacity (F) vs. Storage Capacity (Φ) curves are the dynamic counterparts to the static F-C curves, and are calculated based on the streamline analysis performed at operation 54. Dynamic heterogeneity for the earth model is computed at an operation 58. The dynamic heterogeneity is computed from the Flow Capacity (F) vs. Storage Capacity (Φ) curves constructed for the earth model at operation 56.

The earth model obtained at operation 52 (e.g., as produced by one or more of operations 12, 14, and/or 16 shown in FIG. 1), provide numerical representations of the geological volume of interest. The earth model captures the geological uncertainty in the spatial distributions of reservoir properties. Streamline simulation can be performed for the earth model to evaluate the geological uncertainty of the subsurface reservoir and the dynamic heterogeneity in the earth model. The streamline model of the geological volume of interest solves for fluid pressures on a grid and construct streamlines to describe flow geometry between sources and sinks within the obtained model of the geological volume of interest. Streamlines are constructed such that they are normal to the pressure field. Furthermore, streamlines can take any arbitrary shape as they are not constructed along a finite difference grid.

By modeling the fluid flow within the reservoir along streamlines, the distribution of flow paths within complex geology can be resolved. The fluid flow behavior can also be visually depicted to better understand the geology and flow paths of the subsurface reservoir. There are many commercially available products for performing 3D streamline simulation such as FrontSim™ from Schlumberger Limited, which is headquartered in Houston, Tex.

Streamline simulation is performed for compressible fluids by solving the pressure equation at various times during the simulation. However, multiple pressure solutions are calculated if displacement forces are not balanced. For example, if the mobility ratio is not unity or buoyancy forces are significant then multiple pressure solutions can be computed. In these cases, the distribution in streamlines is not at steady state and therefore, varies in time. This causes ambiguity in describing heterogeneity, since intuitively heterogeneity is a property of the reservoir model and not the displacement mechanism.

In one or more embodiments of the present invention, it is therefore desirable to have conditions of constant compressibility, single phase flow, a mobility ratio of one, and no density differences while performing streamline simulation. Constant or small compressibility is typically easier to solve numerically than incompressible flow. Additionally, transients associated with compressible fluids can be attenuated very rapidly during streamline simulation. For example, simulation can be performed for a few time steps to attenuate pressure transients. Single phase flow precludes capillary forces from interacting with heterogeneity. With no viscous or buoyancy imbalances, the flow geometry can rapidly be evaluated. Thus, given these conditions, the analysis describes the heterogeneity itself and not its interaction with body forces.

The output from streamline simulation is analyzed in operation 54. Analysis of the streamline model includes computing flow geometry using the “time of flight” (TOF) of the streamlines, τᵢ, and their volumetric flow rate, qᵢ. The “time of flight” (TOF) of the streamlines is the time required for a volume of fluid to move from the start of a streamline, which is at the injector well, to the end of a streamline, which is at the production well. From this analysis, flow geometry and sweep efficiency of a given model can be estimated.

Flow Capacity (F) vs. Storage Capacity (Φ) curves are constructed in operation 56 of method 50 using streamlines. Flow Capacity (F) vs. Storage Capacity (Φ) curves that are derived from streamline simulation can be considered as a dynamic estimate of heterogeneity. A streamline simulator can be operated a few time steps so pressure transients are attenuated and the simulation is at steady state. The volumetric flow rate and “time of flight” output, which were obtained from streamline analysis in operation 54, are used to calculate the individual streamlines' pore volume. The pore volume of the i^{th} streamline is determined by:

Vpᵢ=qᵢτᵢ (Equation 5)

where Vpᵢ is the pore volume, qᵢ is the volumetric flow rate assigned to the streamline, and is the time of flight (TOF). The streamlines are ordered according to increasing residence time, such that they are arranged with a decreasing value of q/Vp. The flow capacity (F) and storage capacity (Φ) is calculated and plotted using the following:

$${F}_{i} = \frac{{\sum }_{j = 1}^{i} {q}_{j}}{{\sum }_{j = 1}^{N} {q}_{i}} and {Φ}_{i} = \frac{{\sum }_{j = 1}^{i} {Vp}_{j}}{{\sum }_{j = 1}^{N} {Vp}_{j}} \qquad ( Equation 6 )$$

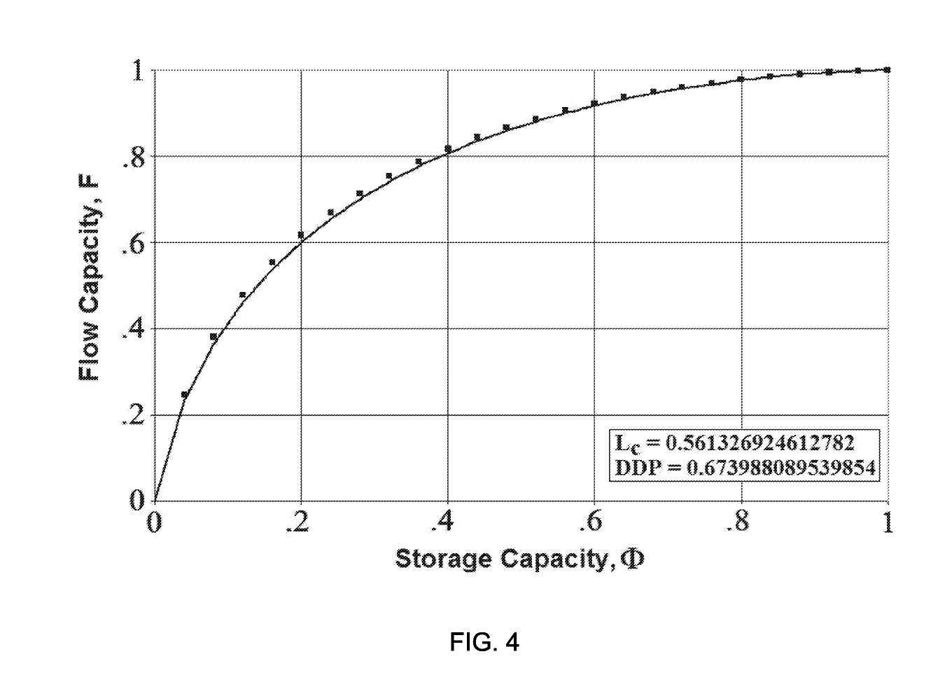

FIG. 4 shows an example comparing a streamline-derived F-Φ curve to the static analytical calculation using Equations 1-4 from input values of permeability, porosity, and layer thickness. The analytic calculation of F-Φ is shown in symbols, while the solid line depicts the F-Φ curve obtained from streamline behavior. In this example, the streamlines are parallel, so all flowpath lengths are equal, and streamline “time of flight” is proportional only to k/Φ. Due to this, the F-Φ curve derived from streamline simulation, which can be considered a dynamic estimate, agrees with the static calculation. However, typically streamlines have arbitrary or nonuniform length, so the streamline “time of flight” is proportional to both k/Φ and streamline length. Accordingly, dynamic Flow Capacity (F) vs. Storage Capacity (Φ) curves typically cannot be inferred a priori from static data.

Referring back to FIG. 3, at operation 58, a measure of dynamic heterogeneity responsive to the Flow Capacity (F) vs. Storage Capacity (Φ) curve is computed for the earth model. Dynamic measures of heterogeneity take into account flow geometry within the geological volume of interest such as a variable flow path length, which is common in heterogeneous media. During secondary recovery of a reservoir within the geological volume of interest, fluid such as water, chemicals, gas, or a combination thereof, is injected into the reservoir to maintain reservoir pressure and displace hydrocarbons toward the production well. Fluid flow within the subsurface reservoir can greatly be impacted depending on the connectivity between the production well and the fluid injection well. Dynamic measures of heterogeneity can be estimated directly from a tracer test or streamline residence times, as these methods account for flow geometry within a subsurface reservoir.

To compute the measure of dynamic heterogeneity for the earth model, a Dynamic Heterogeneity Index (DHI) is utilized. The Dynamic Heterogeneity Index is constructed so that model performance is sensitive to the Dynamic Heterogeneity Index. For example, a change in the Dynamic Heterogeneity Index should correspond to a measurable change in the production behavior of the earth model. Additionally, the relationship between the Dynamic Heterogeneity Index and the production behavior of the model should be unique, so that a reported change in the Dynamic Heterogeneity Index can be interpreted as a known change in production performance. Finally, the Dynamic Heterogeneity Index should be a meaningful measure of some property of the model that can be readily identified and measured.

One example of a Dynamic Heterogeneity Index is the Lorenz coefficient, L_{c}. The Lorenz coefficient is defined as

$${L}_{C} = 2 ( {\int }_{0}^{1} F d Φ - 0.5 ) \qquad ( Equation 7 )$$

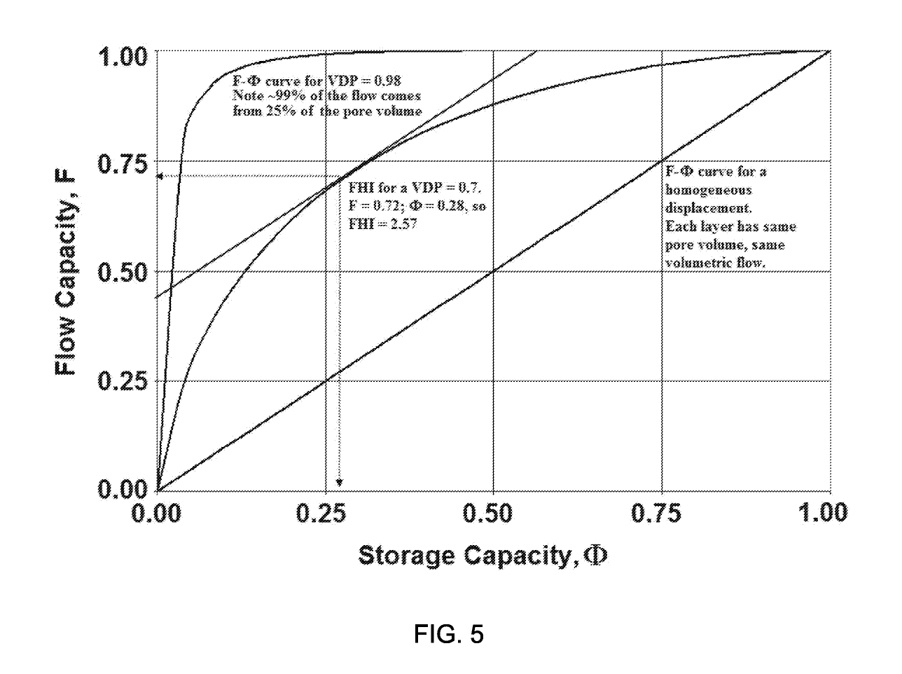

A Lorenz coefficient of zero falls along the 45° line on the F-Φ curve that represents a homogeneous displacement. Therefore, if the Lorenz coefficient is zero, there is equal volumetric flow from every incremental pore volume. A Lorenz coefficient value of one is referred to as “infinitely heterogeneous,” and can be interpreted as all of the flow coming from a very small portion of the pore volume. Schematically this is shown in FIG. 5.

Another example of a Dynamic Heterogeneity Index is the Flow Heterogeneity Index (FHI). The Flow Heterogeneity Index is the value of F/Φ on the flow capacity-storage capacity diagram where the tangent to the curve has unit slope. Therefore,

$$FHI = \frac{F}{Φ} {\vert}_{m = 1} \qquad ( Equation 8 )$$

and the derivative of the F-Φ curve is

$$\frac{d F}{d Φ} = \frac{{t}^{*}}{{τ}_{i}} \qquad ( Equation 9 )$$

where t* is the mean residence time of all streamlines and τ is the “time of flight” of the i^{th} streamline. The Flow Heterogeneity Index can therefore, be interpreted as representing a bulk flow vs. storage capacity of the domain. For homogeneous displacements, the Flow Heterogeneity Index is equal to one, the Flow Heterogeneity Index has no upper limit. The Flow Heterogeneity Index is also shown schematically in FIG. 5.

Another example of a Dynamic Heterogeneity Index is the Coefficient of Variation of the streamline “time of flight”. The Coefficient of Variation is defined as

$${C}_{V} = \frac{\sqrt{Var ( τ )}}{{t}^{*}} \qquad ( Equation 10 )$$

where Var(τ) is the variance of the residence time distribution, which is the second temporal moment of the “time of flight” distribution, and t* is the mean residence time of all streamlines.

Several more examples of a Dynamic Heterogeneity Index are obtained from the sweep efficiency history. Sweep is defined as:

$$Ev ( t ) = \frac{\begin{matrix}Volume of reservoir contacted by \\ displacing agent at time t\end{matrix}}{Total pore volume} \qquad ( Equation 12 )$$

A sweep efficiency history plot can be described as a second diagnostic plot that is readily obtained from F-Φ data. For example, swept volume as a function of time can be determined from the streamline time of flight distribution. Sweep efficiency can also be determined directly from F-Φ data using the equation:

$${E}_{V} = \frac{q}{{V}_{P}} {\int }_{0}^{t} [ 1 - F ( τ ) ] d τ \qquad ( Equation 13 A )$$

Furthermore, sweep efficiency can be estimated graphically from a F-Φ diagram as:

$${E}_{v} ( t ) = Φ ( t ) + \frac{1 - F ( t )}{\frac{d F}{d Φ}} \qquad ( Equation 13 B )$$

Using this procedure, the F-Φ curve can be interpreted as a generalized fractional flow curve, such that it describes displacements in 3-D.

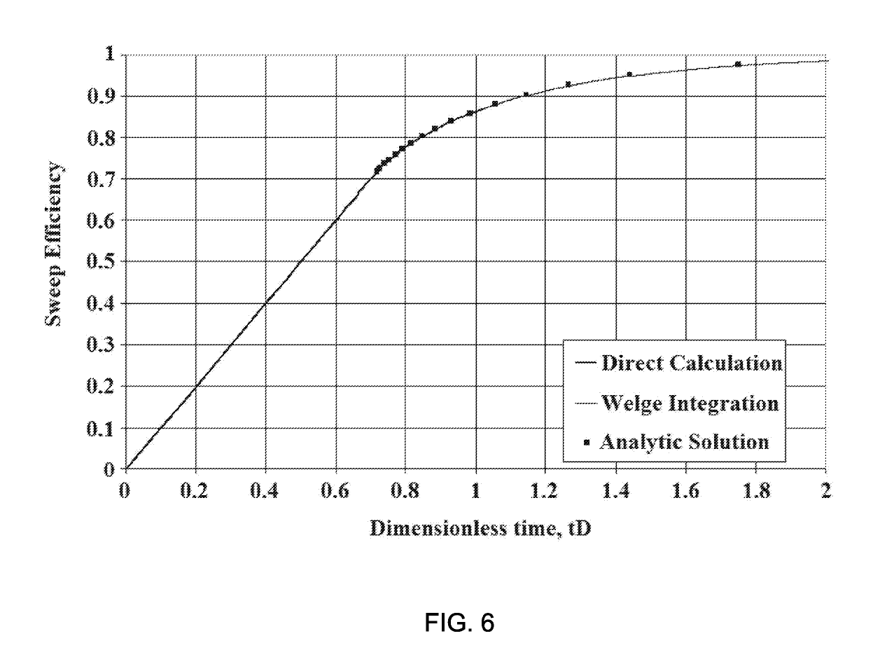

FIG. 6 illustrates sweep efficiency for a homogeneous 5-spot well pattern estimated using various methods responsive to streamline data. The curves are indistinguishable, and agree well with the analytical solution to the problem.

One example of using sweep efficiency as the Dynamic Heterogeneity Index is to use the sweep efficiency at the mean residence time. Therefore, sweep efficiency is at one pore volume injected, or t_{D}=1. Another example of using sweep efficiency for the Dynamic Heterogeneity Index is to use the sweep efficiency at breakthrough, which is reported to be the inverse of the Koval Factor.

Flow capacity, F, at fixed dimensionless time, t_{D}, can also be used as a Dynamic Heterogeneity Index. For example, in cases where the volumetric flow rate is equal among streamlines, such as in incompressible flow or at steady state, flow capacity can be interpreted as the fraction of streamlines that have broken through at any time. Therefore, flow capacity at 0.5 pore volumes injected is an example of a Dynamic Heterogeneity Index. Flow capacity at 1 pore volumes injected is another example of a Dynamic Heterogeneity Index.

These examples of Dynamic Heterogeneity Indices are measures of dynamic heterogeneity because they are developed from the Flow Capacity (F) vs. Storage Capacity (Φ) curve based on streamline simulation or dynamic data. Each example can be readily measured for a given simulation. A summary of these examples are below:

| Name | Formula | Description |
|---|---|---|
| Lc | ${L}_{C} = 2 ( {\int }_{0}^{1} F d Φ - 0.5 )$ | Standard statistical measure of CDFs; a measure of deviation from a homogeneous model |
| FHI | ${FHI = \frac{F}{Φ} \vert}_{m = 1}$ | The ratio of Flow-to-Storage where the F-Φ curve has unit slope (which is represented of mean bulk flow) |
| Cv | ${C}_{V} = \frac{\sqrt{Var ( τ )}}{{t}^{*}}$ | Coefficient of variation, recognized as ‘dimensionless variance’ |
| Ev at BT | | Sweep efficiency at breakthrough |
| Ev at t_{D} = 1 | | Sweep efficiency at 1 pore |
| | | volume injected |
| F at t_{D} = 0.5 | | Fraction of streamlines broken |
| | | through at 0.5 pore volumes |
| | | injected |
| F at t_{D} = 1 | | Fraction of streamlines broken |
| | | through at 1 pore volume |
| | | injected |

The Dynamic Heterogeneity Index can be, but is not limited to, one of these examples.

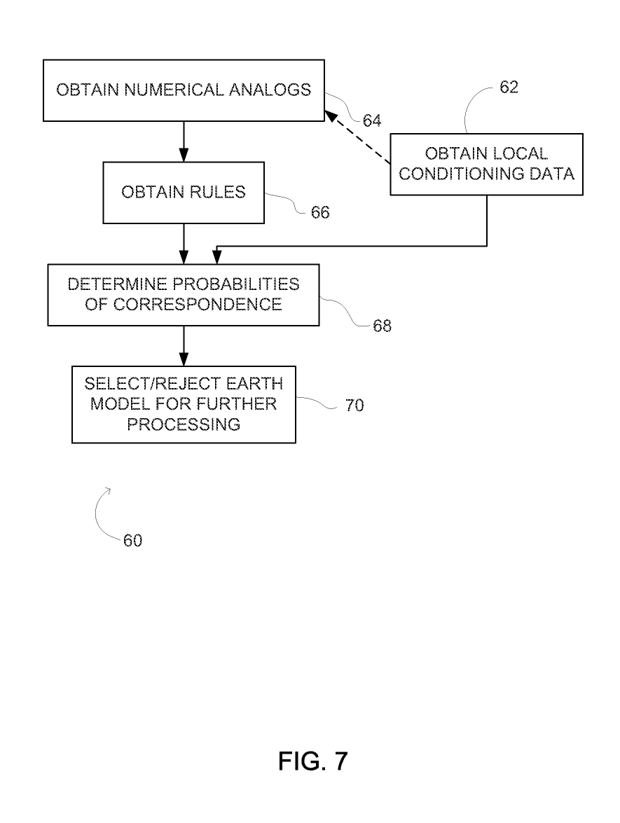

FIG. 7 illustrates a method 60 of assessing likelihood of earth models of a geological volume of interest. In some embodiments, method 60 may be implemented as operation 24 of method 10 (shown in FIG. 1). It will be appreciated that this is not intended to be limiting, as method 60 may be implemented within a variety of contexts consistent with the principles described herein.

At an operation 62, conditioning information for the geological volume of interest is obtained. The conditioning information may include conditioning information obtained at operation 12 of method 10 (shown in FIG. 1). The conditioning information includes information related to the characteristics of the geologic volume of interest.

At an operation 64, an earth model of the geological volume of interest is obtained. The earth model may have been generated by operations the same as or similar to operations 12, 14, 16, 18, and/or 20 of method 10 (shown in FIG. 1). Operation 64 may include obtaining further information about the geological volume of interest as represented by the earth model. For example, at operation 64, a dynamic heterogeneity of the earth model may be obtained. The dynamic heterogeneity may be determined as described with respect to operation 22 of method 10 (shown in FIG. 1).

At an operation 66, rules related to interdependencies between characteristics of the geological volume of interest, as represented by the earth model, are obtained. These rules provide quantification of interactions between the geologic characteristics that can be used to constrain architectural uncertainty, and/or to facilitate prediction of geological architecture. By way of non-limiting example, the rules obtained at operation 66 may quantify the interaction between one or more of aggradation rate and concentration of net reservoir volume (e.g., lower rates of aggradation tend to result in higher concentrations of net reservoir volume), avulsion rate and connectivity (e.g., higher avulsion rates tend to result in lower connectivity), lateral stepping and preservation of potential channel axis within channel elements (e.g., in deepwater channels, lateral stepping tends to reduce the preservation of potential channel axis within channel elements), and/or other interactions. One or more of the rules may be based on an interdependencies of heterogeneity (or dynamic heterogeneity) with one or more other characteristics of the earth model.

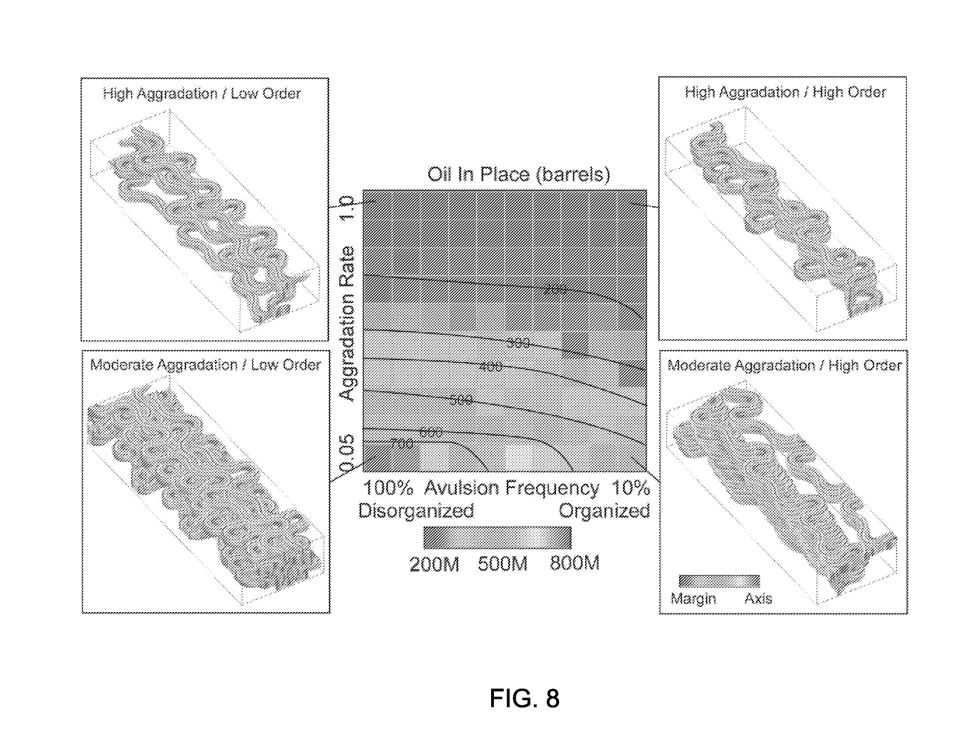

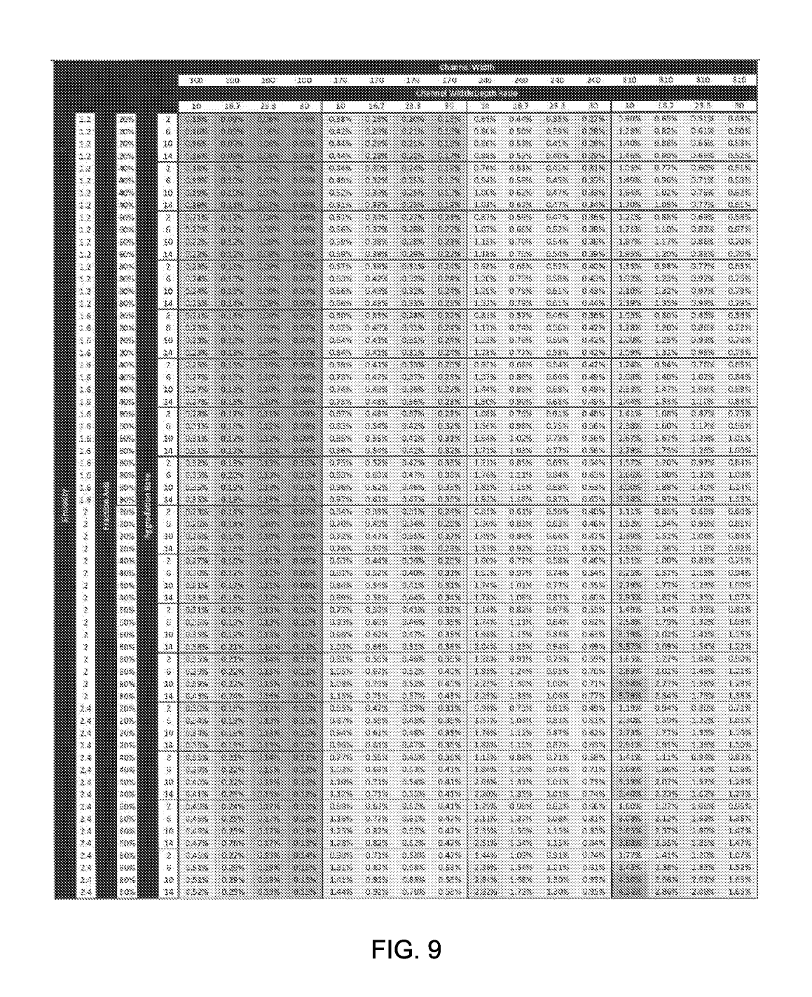

The rules obtained at operation 66 may include one or more of general rules, sensitivities, response surfaces, look up tables, multivariate regression modules, and/or other rules that quantify interactions between geologic characteristics. By way of illustration, FIG. 8 shows a response surface quantifying the interaction between net reservoir volume, aggradation rate, and frequency of avulsion within an architectural element (e.g., within a channel). As another example, FIG. 9 shows a look-up table quantifying the interaction between net reservoir volume and geologic characteristics and/or features for disorganized channel settings.

Referring back to FIG. 7, in some embodiments, operation 66 is configured to obtain one or more rules for the geologic volume of interest that have been predetermined. The predetermined rule(s) may be specific to a type of depositional setting and/or reservoir type that corresponds to the geologic volume of interest, or may be more generic. The predetermined rule(s) may have been generated by another system based on previous analysis of local conditioning data and/or numerical analogs representing the geologic volume of interest. Operation 66 may enable one or more users to modify or configure the predetermined rule(s) (e.g., via a user interface) prior to implementation.

In some embodiments, operation 66 is configured to generate one or more of the rules based on analysis of the earth model of the geologic volume of interest, alone or in conjunction with other earth models of the geological volume of interest. The rules may be generated by observing cumulative relationships between the characteristics described by a plurality of earth models of the geological volume of interest over the totality of the earth models. For example, a relatively high level of one characteristic may commonly, within the set of earth models, be found in conjunction with a relatively low level of another characteristic. This relationship may be quantified at operation 66 in the form of a rule. It will be appreciated that this simplistic example is not intended to be limiting, and more complex relationships between two or more characteristics and/or geologic features defined by such characteristics quantified by rules created through analysis of a set of earth models for the geologic volume of interest fall within the scope of this disclosure.

The generation of rules described above through analysis of the numerical analogs obtained for the geologic volume of interest (whether such analysis is actually performed at operation 66, or subsequently determined rules are obtained at operation 66) may provide various enhancements in the estimation of the geological architecture of the geologic volume of interest. For instance, the rules may quantify interdependencies between geologic characteristics that are specific to the geologic volume of interest and/or that appear distant or tenuous by traditional understandings of the interactions between geologic characteristics.

In some embodiments, the obtained rules may be presented to the user(s) (e.g., via a user interface) at operation 66. This enables the user(s) to review the rules prior to implementation to examine in greater detail rules that seem to the user(s) to be the result of a statistical anomaly in the numerical analogs obtained at operation 66. Once the user(s) has reviewed an apparently anomalous rule, and/or the basis for the rule, the user may reject the rule so that the rule will not be used in further processing, or to modify the rule.

At an operation 68, probabilities of correspondence are determined and/or assigned to the earth model. The probability of correspondence assigned to earth model expresses a probability that the actual geological architecture of the geologic volume of interest corresponds to the geological architecture described by the earth model. The probability of correspondence for the earth model is determined by comparing the geological architecture described by the earth model with the local conditioning data, and by applying the rules related to interdependencies obtained at operation 66 to the earth model and/or the local conditioning data with respect to the earth model.

At an operation 70, a determination is made as to whether the earth model should be accepted or rejected for further analysis. This determination is made based on the probability determined at operation 68. For example, responsive to the probability being over a threshold level, the earth model may be accepted for further analysis, while responsive to the probability being below the threshold level, the earth model may be rejected. The threshold level may be predetermined, set based on user input, determined based on probabilities determined for the present earth model and a set of earth models of the geological volume of interest (e.g., accepting some amount of the set and rejecting some amount of the set), and/or set in other ways.

The operations of methods 10, 30, 50, and 60 described herein and shown in FIGS. 1, 2, 3, and 7 are intended to be illustrative. In some embodiments, one or more of methods 10, 30, 50, and/or 60 may be accomplished with one or more additional operations not described, and/or without one or more of the operations discussed. Additionally, the order in which the operations of methods 10, 30, 50, and/or 60 are illustrated in FIGS. 1, 2, 3, and 7 and described herein is not intended to be limiting.

In some embodiments, one or more of methods 10, 30, 50, and/or 60 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of methods 10, 30, 50, and/or 60 in response to instructions stored electronically on an electronic storage medium. The one or more processing devices may include one or more devices configured through hardware, firmware, and/or software to be specifically designed for execution of one or more of the operations of methods 10, 30, 50, and/or 60.

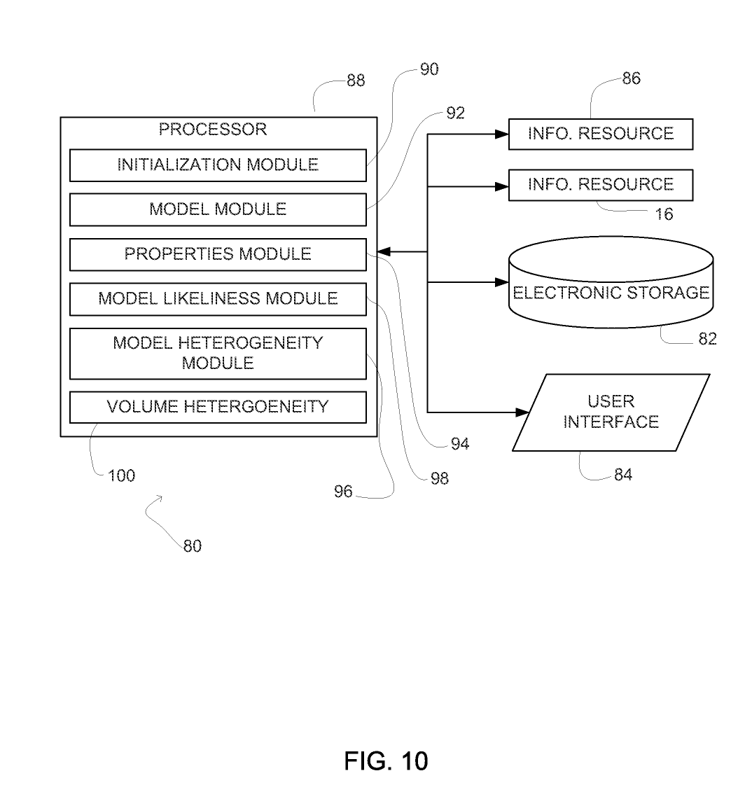

FIG. 10 illustrates a system 80 configured to assess the heterogeneity of a geological volume of interest. In some implementations, system 80 is configured to implement one or more of methods 10, 30, 50, and/or 60 shown in FIGS. 1, 2, 3, and/or 7, respectively, and described herein. In one embodiment, system 80 includes electronic storage 82, a user interface 84, one or more information resources 86, a processor 88, and/or other components.

In one embodiment, electronic storage 82 comprises electronic storage media that electronically stores information. The electronically storage media of electronic storage 82 may include one or both of system storage that is provided integrally (i.e., substantially non-removable) with system 80 and/or removable storage that is removably connectable to system 80 via, for example, a port (e.g., a USB port, a firewire port, etc.) or a drive (e.g., a disk drive, etc.). Electronic storage 82 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 82 may store software algorithms, information determined by processor 88, information received via user interface 84, information obtained from information resources 86, and/or other information that enables system 80 to function properly. Electronic storage 82 may be a separate component within system 80, or electronic storage 82 may be provided integrally with one or more other components of system 80 (e.g., processor 88) in a single device (or set of devices).

User interface 84 is configured to provide an interface between system 80 and one or more users through which the user(s) may provide information to and receive information from system 80. This enables data, results, and/or instructions and any other communicable items, collectively referred to as “information,” to be communicated between the user(s) and one or more of electronic storage 82, information resources 86, and/or processor 88. Examples of interface devices suitable for inclusion in user interface 84 include a keypad, buttons, switches, a keyboard, knobs, levers, a display screen, a touch screen, speakers, a microphone, an indicator light, an audible alarm, and a printer.

It is to be understood that other communication techniques, either hard-wired or wireless, are also contemplated by the present invention as user interface 84. For example, the present invention contemplates that user interface 84 may be integrated with a removable storage interface provided by electronic storage 82. In this example, information may be loaded into system 80 from removable storage (e.g., a smart card, a flash drive, a removable disk, etc.) that enables the user(s) to customize the implementation of system 80. Other exemplary input devices and techniques adapted for use with system 80 as user interface 84 include, but are not limited to, an RS-232 port, RF link, an IR link, modem (telephone, cable or other). In one embodiment, user interface 84 may be provided on a computing platform in operative communication with a server performing some or all of the functionality attributed herein to system 80. In short, any technique for communicating information with system 80 is contemplated by the present invention as user interface 84.

The information resources 86 include one or more sources of information related to the geologic volume of interest and/or the process of estimating the geological architecture of geologic volume of interest. By way of non-limiting example, one of server 16 may include a set of previously determined rules related to the distributions of the characteristics of the geologic volume of interest. As is discussed further below, these rules may include one or more of relationships between one or more specific geological characteristics and one or more environmental parameters, interdependencies between a plurality of geological characteristics, constraints on one or more geological characteristics, and/or other rules related to the distributions of the characteristics of the geologic volume of interest. The rules may include rules that are generic to all (or substantially all) modeled geologic volumes, and/or rules that are specific to individual types of classes of reservoirs, depositional settings, geological areas, and/or other groups or sets of geologic volumes. The rules may include rules that are entered and/or modified by one or more users (e.g., via user interface 84), and/or rules that are automatically determined (e.g., by processor 88, or some other processor, as discussed below).

As another non-limiting example of information resources 86, one of information resources 86 may include a dataset including local conditioning data for one or more geological volumes. As used herein, “local conditioning data” refers to measurements taken at a geologic volume of one or more characteristics of the geologic volume. For instance, “local conditioning data” may include measurements taken from equipment positioned within one or more wells drilled at or near a geologic volume, seismic data (or information derived therefrom) acquired at the surface at or near a geologic volume, and/or other measurements of one or more characteristics of a geologic volume.

Processor 88 is configured to provide information processing capabilities in system 80. As such, processor 88 may include one or more of a digital processor, an analog processor, a digital circuit designed to process information, an analog circuit designed to process information, a state machine, and/or other mechanisms for electronically processing information. Although processor 88 is shown in FIG. 1 as a single entity, this is for illustrative purposes only. In some implementations, processor 88 may include a plurality of processing units. These processing units may be physically located within the same device, or processor 88 may represent processing functionality of a plurality of devices operating in coordination.

As is shown in FIG. 1, processor 88 may be configured to execute one or more computer program modules. The one or more computer program modules may include one or more of an initialization module 90, a model module 92, a properties module 94, a model heterogeneity module 96, a model likeliness module 98, a volume heterogeneity module 100, and/or other modules. Processor 88 may be configured to execute modules 90, 92, 94, 96, 98, and/or 100 by software; hardware; firmware; some combination of software, hardware, and/or firmware; and/or other mechanisms for configuring processing capabilities on processor 88.

It should be appreciated that although modules 90, 92, 94, 96, 98, and/or 100 are illustrated in FIG. 10 as being co-located within a single processing unit, in implementations in which processor 88 includes multiple processing units, one or more of modules 90, 92, 94, 96, 98, and/or 100 may be located remotely from the other modules. The description of the functionality provided by the different modules 90, 92, 94, 96, 98, and/or 100 described below is for illustrative purposes, and is not intended to be limiting, as any of modules 90, 92, 94, 96, 98, and/or 100 may provide more or less functionality than is described. For example, one or more of modules 90, 92, 94, 96, 98, and/or 100 may be eliminated, and some or all of its functionality may be provided by other ones of modules 90, 92, 94, 96, 98, and/or 100. As another example, processor 88 may be configured to execute one or more additional modules that may perform some or all of the functionality attributed below to one of modules 90, 92, 94, 96, 98, and/or 100.

Initialization module 90 is configured to initialize the generation of one or more earth models of the geological volume of interest. In some embodiments, this may include performing some or all of the functionality described above with respect to operation 12 (shown in FIG. 1 and described herein).

Model module 92 is configured to stochastically generate a set of process-based models of the geological volume of interest. In generating the set of process-based models, individual geological process events are stochastically generated and/or selected successively. In some embodiments, model module 92 is configured to perform some or all of the functionality described above with respect to operations 14 and 16 (shown in FIG. 1 and described herein).

Properties module 94 is configured populate earth models of the geological volume of interest with one or more properties as a function of position within the earth models. In some embodiments, properties module 94 may perform some or all of the functionality described above with respect to operations 18 and 20 (shown in FIG. 1 and described herein).

Model heterogeneity module 96 is configured to calculate dynamic heterogeneities for the individual models in the set of process-based models of the geological volume of interest. In some embodiments, this may include performing some or all of the functionality described above with respect to operation 22 (shown in FIG. 1 and described herein).

Model likeliness module 98 is configured to implement the process-based models and/or the calculated dynamic heterogeneities to assess likeliness of the individual process-based models corresponding to the actual geology of the geological volume of interest. This may include comparing flow responses of the individual process-based models with observed production data, evaluating individual process-based models using rules relating to the interdependencies of characteristics of the process-based models, and/or other techniques for assessing likeliness. In some embodiments, model likeliness module 98 is configured to perform some or all of the functionality described above with respect to operation 24 (shown in FIG. 1 and described herein).

Volume heterogeneity module 100 is configured to analyze the dynamic heterogeneities determined for the individual models in the set of process-based models to obtain a quantification of likely heterogeneity of at least a portion of the geological volume of interest. In some embodiments, volume heterogeneity module 100 is configured to perform some or all of the functionality described above with respect to operation 26.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A method of generating a geostatistical model of a geological volume of interest, the method comprising:
stochastically generating a set of process-based models of the geological volume of interest, including a first model and a second model, wherein generating the first model includes separately stochastically generating a plurality of successive geological process events to form the first model of the geological volume of interest, and wherein generating the second model includes separately stochastically generating a plurality of successive geological process events to form the second model of the geological volume of interest;
calculating dynamic heterogeneities for the individual models in the set of process-based models of the geological volume of interest such that a dynamic heterogeneity for the first model is determined and a dynamic heterogeneity for the second model is determined; and
analyzing the dynamic heterogeneities determined for the individual models in the set of process-based models to obtain a quantification of likely heterogeneity of at least a portion of the geological volume of interest.

2. The method of claim 1, further comprising obtaining conditioning information associated with the geological volume of interest, wherein the conditioning information includes information derived from measurements made at or near the geological volume of interest, and wherein the process-based models are conformed during generation to the conditioning information associated with the geological volume of interest.

3. The method of claim 2, wherein conforming the first model to the conditioning information associated with the geological volume of interest comprises, for a given geological process event in the first model:
determining a set of constraints for the given geological process event from the conditioning information;
stochastically generating a plurality of potential process events that conform to the set of constraints; and
selecting one of the potential process events as the given geological process for inclusion in the first model.

4. The method of claim 1, wherein the calculation of dynamic heterogeneity for the first model comprises calculating a metric that represents dynamic heterogeneity locally within a portion of the first model, and/or calculating a metric that represents dynamic heterogeneity globally throughout the first model.

5. The method of claim 1, further comprising performing a streamline analysis on the individual process-based models, wherein performing the streamline analysis on the first model comprises identifying a plurality of streamlines indicative of flow geometry within the first model, and wherein the calculations of dynamic heterogeneity for the individual process-based models are based on the streamline analysis of the individual process-based models.

6. The method of claim 1, wherein analyzing the dynamic heterogeneities calculated for the individual models in the set of process-based models to obtain a quantification of likely heterogeneity of at least a portion of the geological volume of interest comprises identifying a range of likely heterogeneities based on the calculated dynamic heterogeneities.

7. The method of claim 1, further comprising:
implementing the determined dynamic heterogeneities and the process-based models to compare flow responses of the individual process-based models to observed production data from the geological volume of interest;
assessing likeliness of the individual process-based models corresponding to the actual geology of the geological volume of interest based on the comparisons of flow response to the observed production data.

8. A system configured to generate a geostatistical model of a geological volume of interest, the system comprising:
one or more processors configured to execute computer program modules, the computer program modules comprising:
a model module configured to stochastically generate a set of process-based models of the geological volume of interest, including a first model and a second model, wherein the model module is configured such that generating the first model includes separately stochastically generating a plurality of successive geological process events to form the first model of the geological volume of interest, and such that generating the second model includes separately stochastically generating a plurality of successive geological process events to form the second model of the geological volume of interest;
a model heterogeneity module configured to calculate dynamic heterogeneities for the individual models in the set of process-based models of the geological volume of interest such that a dynamic heterogeneity for the first model is determined and a dynamic heterogeneity for the second model is determined; and
a volume heterogeneity module configured to analyze the dynamic heterogeneities determined for the individual models in the set of process-based models to obtain a quantification of likely heterogeneity of at least a portion of the geological volume of interest.

9. The system of claim 8, wherein the computer program modules further comprise an initialization module configured to obtain conditioning information associated with the geological volume of interest, wherein the conditioning information includes information derived from measurements made at or near the geological volume of interest, and wherein the model module is configured such that the process-based models are conformed during generation to the conditioning information associated with the geological volume of interest.

10. The system of claim 9, wherein the model module is configured such that conforming the first model to the conditioning information associated with the geological volume of interest comprises, for a given geological process event in the first model:
determining a set of constraints for the given geological process event from the conditioning information;
stochastically generating a plurality of potential process events that conform to the set of constraints; and
selecting one of the potential process events as the given geological process for inclusion in the first model.

11. The system of claim 8, wherein the model heterogeneity module is further configured such that the calculation of dynamic heterogeneity for the first model comprises calculating a metric that represents dynamic heterogeneity locally within a portion of the first model, and/or calculating a metric that represents dynamic heterogeneity globally throughout the first model.

12. The system of claim 8, wherein the model heterogeneity module is further configured to perform a streamline analysis on the individual process-based models, wherein performing the streamline analysis on the first model comprises identifying a plurality of streamlines indicative of flow geometry within the first model, and wherein heterogeneity module is configured such that the calculations of dynamic heterogeneity for the individual process-based models are based on the streamline analysis of the individual process-based models.

13. The system of claim 8, wherein the volume heterogeneity module is further configured such that analyzing the dynamic heterogeneities calculated for the individual models in the set of process-based models to obtain a quantification of likely heterogeneity of at least a portion of the geological volume of interest comprises identifying a range of likely heterogeneities based on the calculated dynamic heterogeneities.

14. The system of claim 8, wherein the computer program modules further comprise a model likeliness module configured to implement the determined dynamic heterogeneities and the process-based models to compare flow responses of the individual process-based models to observed production data from the geological volume of interest, and to assess likeliness of the individual process-based models corresponding to the actual geology of the geological volume of interest based on the comparisons of flow response to the observed production data.

15. A non-transitory, electronic storage medium having stored thereon processor readable instructions, wherein the instructions are configured to cause one or more processors to perform a method of generating a geostatistical model of a geological volume of interest, the method comprising:
stochastically generating a set of process-based models of the geological volume of interest, including a first model and a second model, wherein generating the first model includes separately stochastically generating a plurality of successive geological process events to form the first model of the geological volume of interest, and wherein generating the second model includes separately stochastically generating a plurality of successive geological process events to form the second model of the geological volume of interest;
calculating dynamic heterogeneities for the individual models in the set of process-based models of the geological volume of interest such that a dynamic heterogeneity for the first model is determined and a dynamic heterogeneity for the second model is determined; and
analyzing the dynamic heterogeneities determined for the individual models in the set of process-based models to obtain a quantification of likely heterogeneity of at least a portion of the geological volume of interest.

16. The storage medium of claim 15, wherein the method further comprises obtaining conditioning information associated with the geological volume of interest, wherein the conditioning information includes information derived from measurements made at or near the geological volume of interest, and wherein the process-based models are conformed during generation to the conditioning information associated with the geological volume of interest.

17. The storage medium of claim 16, wherein conforming the first model to the conditioning information associated with the geological volume of interest comprises, for a given geological process event in the first model:
determining a set of constraints for the given geological process event from the conditioning information;
stochastically generating a plurality of potential process events that conform to the set of constraints; and
selecting one of the potential process events as the given geological process for inclusion in the first model.

18. The storage medium of claim 17, wherein the calculation of dynamic heterogeneity for the first model comprises calculating a metric that represents dynamic heterogeneity locally within a portion of the first model, and/or calculating a metric that represents dynamic heterogeneity globally throughout the first model.

19. The storage medium of claim 15, wherein the method further comprises performing a streamline analysis on the individual process-based models, wherein performing the streamline analysis on the first model comprises identifying a plurality of streamlines indicative of flow geometry within the first model, and wherein the calculations of dynamic heterogeneity for the individual process-based models are based on the streamline analysis of the individual process-based models.

20. The storage medium of claim 15, wherein analyzing the dynamic heterogeneities calculated for the individual models in the set of process-based models to obtain a quantification of likely heterogeneity of at least a portion of the geological volume of interest comprises identifying a range of likely heterogeneities based on the calculated dynamic heterogeneities.
